(19) United States
(12) Patent Application Publication
(10) Pub. No.: US 2017/0144477 A1
(43) Pub. Date: May 25, 2017

(54) Wheel Hub and Wheel Including the Same

(71) Applicant: Chung-Lin Lai, Taichung City (TW)

(72) Inventor: Chung-Lin Lai, Taichung City (TW)

(21) Appl. No.: 15/259,091

(22) Filed: Sep. 8, 2016

(30) Foreign Application Priority Data
Nov. 24, 2015 (TW) 104218825
Feb. 19, 2016 (TW) 105202359

(51) Int. Cl. B60B 1/04; B60B 1/02; B60B 27/00; B60B 1/00; B60B 27/02

(52) U.S. Cl. CPC B60B 1/041; B60B 1/003; B60B 1/042; B60B 27/023; B60B 27/0015; B60B 1/0261

(57) ABSTRACT

A wheel hub is to be mounted with multiple spokes, and includes a hub body extending about a central axis, and two hub shells connected to the hub body. Each of the hub shells includes a base wall, a surrounding wall and a mounting hole unit. The base wall has a first base portion extending radially and outwardly from the hub body, and a second base portion extending from the first base portion in an axial direction relative to the central axis. The surrounding wall extends radially and outwardly from the second base portion. The mounting hole unit includes multiple first mounting holes formed in the base wall, and multiple second mounting holes formed in the surrounding wall. Each of the first and second mounting holes allows for extension of a spoke.

### CROSS-REFERENCE TO RELATED APPLICATION

This application claims priorities of Taiwanese Utility Model Patent Application No. 104218825, filed on Nov. 24, 2015, and Taiwanese Utility Model Patent Application No. 105202359, filed on Feb. 19, 2016.

### FIELD

The disclosure relates to a wheel hub and a wheel including the same.

### BACKGROUND

The wheels for a bicycle are the only components in direct contact with the ground. In concerning the safety of a rider, it is crucial to keep both wheels in perfect circle by the combination of wheel frames, spokes and wheel hubs. A bicycle wheel typically includes a wheel frame, wheel hub, and a plurality of spokes that are made of steel and that are connected between the wheel frame and the wheel hub, thereby generating a pulling force evenly distributed on the wheel frame and inwardly toward the wheel hub to maintain the shape of the wheel frame when under stress, such as a weight of the rider.

Referring to FIGS. 1 and 2, a conventional bicycle wheel includes a wheel frame 1, a wheel hub 2, and a plurality of J-bend spokes 3 that are connected between the wheel frame 1 and the wheel hub 2. The wheel hub 2 includes a cylindrical main body and two shells 21 that are respectively connected to opposite ends of the main body. Each of the shells 21 is formed with a plurality of through holes 211, and permits a corresponding one of the J-bend spokes 3 to be mounted to the shell 21 therethrough. A stress region is defined by the J-bend spokes 3 when rotating about the wheel hub 2. However, when one of the J-bend spokes 3 is detached or broken, the wheel frame 1 is no longer subjected to an evenly distributed pulling force, and may be deformed. Moreover, the wheel hub 2 of the conventional bicycle wheel is only capable of accommodating one kind of spoke, and is unable to accommodate mixed combination of spokes, such as J-bend spokes and straight pull spokes.

### SUMMARY

Therefore, an object of the present disclosure is to provide a wheel hub that can alleviate at least one of the drawbacks associated with the prior art.

According to the present disclosure, the wheel hub is adapted to be mounted with a plurality of spokes. The wheel hub includes a hub body and two hub shells.

The hub body extends about a central axis. The hub shells are respectively connected to opposite ends of the hub body. Each of the hub shells includes a base wall, a surrounding wall and a mounting hole unit, wherein: the base wall has a first base portion extending radially and outwardly from the hub body, and a second base portion extending from the first base portion in an axial direction relative to the central axis; the surrounding wall extends radially and outwardly from the second base portion of the base wall; and the mounting hole unit includes a plurality of first mounting holes formed in the base wall and spaced apart from each other, and a plurality of second mounting holes formed in the surrounding wall and spaced apart from each other. Each of the first and second mounting holes is adapted to permit a corresponding one of the spokes to be mounted to the base wall therethrough.

Another object of the disclosure is to provide a wheel that can alleviate at least one of the drawbacks associated with the prior art.

According to the present disclosure, the wheel includes a wheel hub, a wheel frame, a plurality of first spokes and a plurality of second spokes.

The wheel hub includes a hub body that extends about a central axis, and two hub shells that are respectively connected to opposite ends of the hub body.

Each of the hub shells includes a base wall, a surrounding wall and a mounting hole unit, wherein: the base wall has a first base portion extending radially and outwardly from the hub body, and a second base portion extending from the first base portion in an axial direction relative to the central axis; the surrounding wall extends radially and outwardly from the second base portion of the base wall; and the mounting hole unit includes a plurality of first mounting holes formed in the base wall and spaced apart from each other, and a plurality of second mounting holes formed in the surrounding wall and spaced apart from each other.

The wheel frame surrounds the wheel hub, is rotatable about the central axis, and is formed with a plurality of securing holes spaced apart from each other.

Each of the first spokes has opposite ends that are respectively secured to a corresponding one of the first mounting holes of the mounting hole unit of a corresponding one of the hub shells, and a corresponding one of the securing holes.

Each of the second spokes has opposite ends that are respectively secured into a corresponding one of the second mounting holes of the mounting hole unit of a corresponding one of the hub shells, and a corresponding one of the securing holes.

### BRIEF DESCRIPTION OF THE DRAWINGS

Other features and advantages of the present disclosure will become apparent in the following detailed description of the embodiments with reference to the accompanying drawing, of which:

FIG. 1 is a fragmentary perspective view of a conventional bicycle wheel;

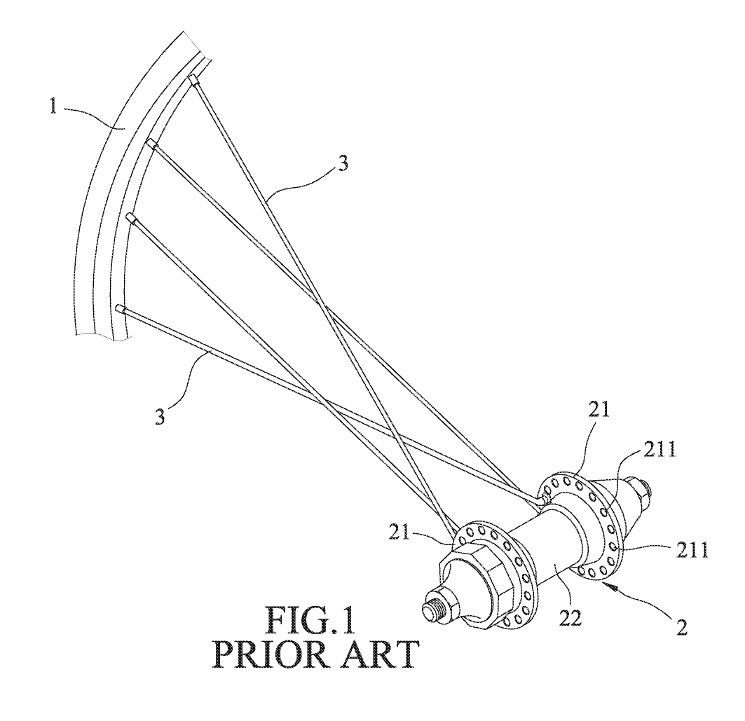

FIG. 2 is a schematic view of the conventional bicycle wheel;

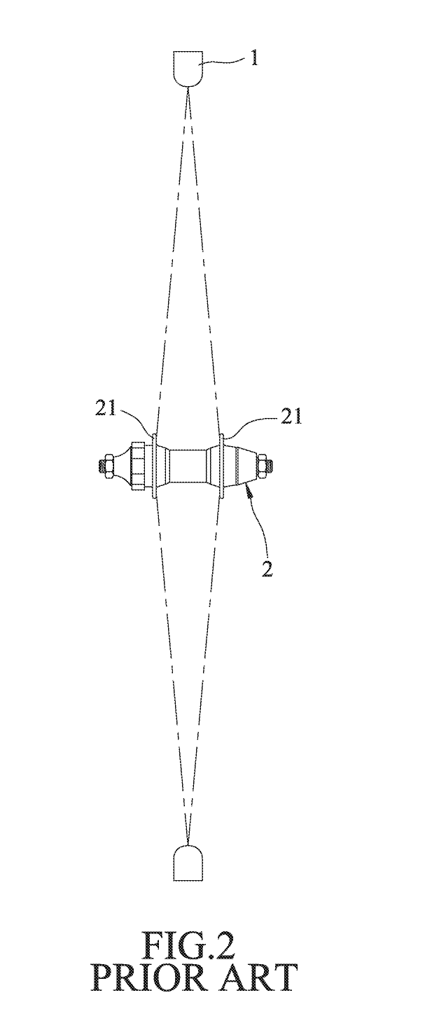

FIG. 3 is a perspective view of a first embodiment of a wheel according to the present disclosure;

FIG. 4 is a perspective view of a wheel hub of the first embodiment;

FIG. 5 is a sectional view taken along line V-V of FIG. 4;

FIG. 6 is a schematic sectional view taken along line VI-VI of FIG. 3, showing first and second imaginary circles of the first embodiment;

FIG. 7 is a schematic front or rear view of the first embodiment;

FIG. 8 is a schematic view of the first embodiment, showing a plurality of first and second spokes that are mounted to the wheel hub;

FIG. 9 is another schematic view of the first embodiment, showing the first and second spokes that are mounted to the wheel hub;

FIG. 10 is a schematic view showing first and second stress regions as indicated in FIG. 7;

FIG. 11 is a side view of the first embodiment;

FIG. 12 is a fragmentary schematic perspective view of a second embodiment of the wheel according to the present disclosure, showing a plurality of first spokes mounted to a wheel hub;

FIG. 13 is a fragmentary schematic partially sectional perspective view of the wheel hub of the second embodiment;

FIG. 14 is an another fragmentary schematic perspective view of the second embodiment, showing the first spokes mounted to the wheel hub;

FIG. 15 is a schematic front or rear view of the second embodiment; and

FIG. 16 is a side view of the second embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

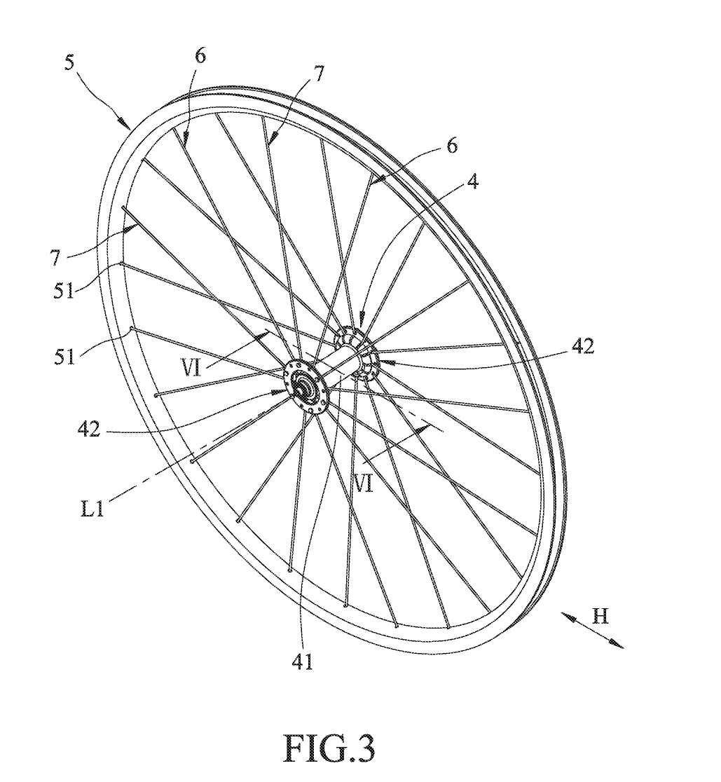

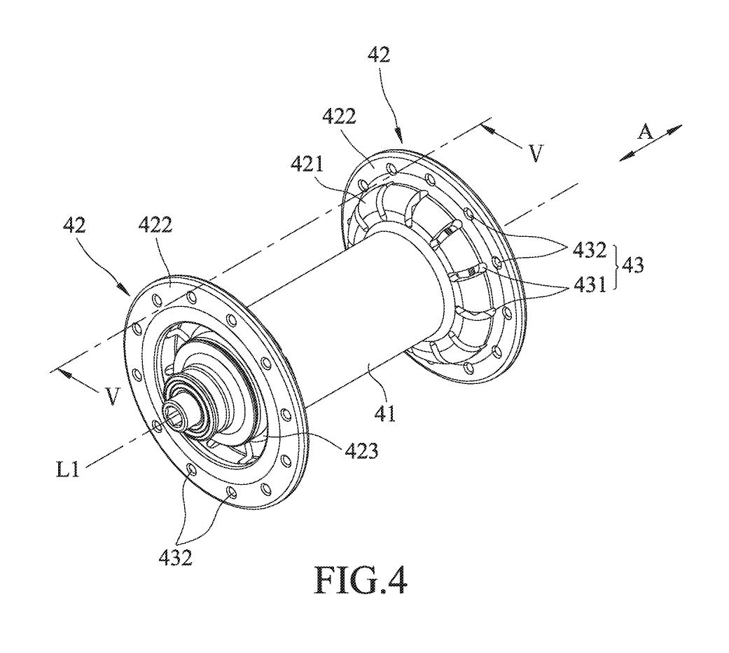

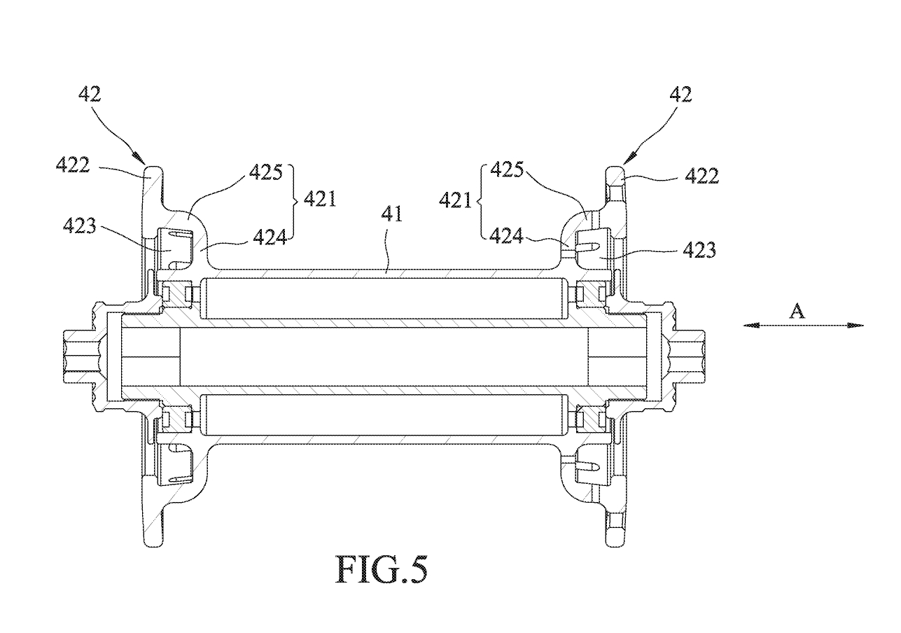

Referring to FIGS. 3 to 5, a first embodiment of a wheel according to the present disclosure includes a wheel hub 4, a wheel frame 5, a plurality of first spokes 6 and a plurality of second spokes 7.

The wheel hub 4 includes a hub body 41 that is cylindrical in shape and that extends about a central axis (L1), and two hub shells 42 that are respectively connected to opposite ends of the hub body 41. Each of the hub shells 42 includes a base wall 421 that has a first base portion 424 extending radially and outwardly from the hub body 41 and a second base portion 425 extending from the first base portion 424 in an axial direction (A) relative to the central axis (L1), a surrounding wall 422 that extends radially and outwardly from the second base portion 425 of the base wall 421, a mounting hole unit 43 that includes a plurality of first mounting holes 431 formed in the base wall 421 and spaced apart from each other, and a plurality of second mounting holes 432 formed in the surrounding wall 422 and spaced apart from each other, and a surrounding space 423 that is defined by the hub body 41, the first base portion 424 and the second base portion 425 and that is in spatial communication with the first mounting holes 431. The second base portion 425 of each of the hub shells 42 extends away from the other one of the hub shells 42. Each of the first mounting holes 431 of the mounting hole unit 43 of each of the hub shells 42 extends from the first base portion 424 of the base wall 421 of the hub shell 42 into the second base portion 425. Each of the second mounting holes 432 of the mounting hole unit 43 of each of the hub shells 42 extends through the surrounding wall 422 of the hub shell 42 in the axial direction (A).

The wheel frame 5 surrounds the wheel hub 4, is rotatable about the central axis (L1), and is formed with a plurality of securing holes 51 that are spaced apart from each other.

Each of the first and second mounting holes 431, 432 of the mounting hole unit 43 of each of the hub shells 42 is adapted to permit a corresponding one of the first and second spokes 6, 7 to be mounted to the base wall 421 of the hub shell 42 therethrough. Specifically, each of the first spokes 6 has opposite ends that are respectively secured into a corresponding one of the first mounting holes 431 of the mounting hole unit 43 of a corresponding one of the hub shells 42, and a corresponding one of the securing holes 51. Each of the second spokes 7 has opposite ends that are respectively secured into a corresponding one of the second mounting holes 432 of the mounting hole unit 43 of a corresponding one of the hub shells 42, and a corresponding one of the securing holes 51.

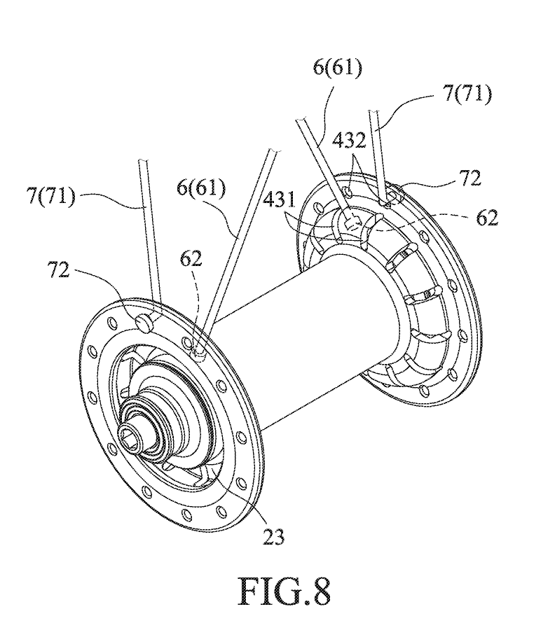

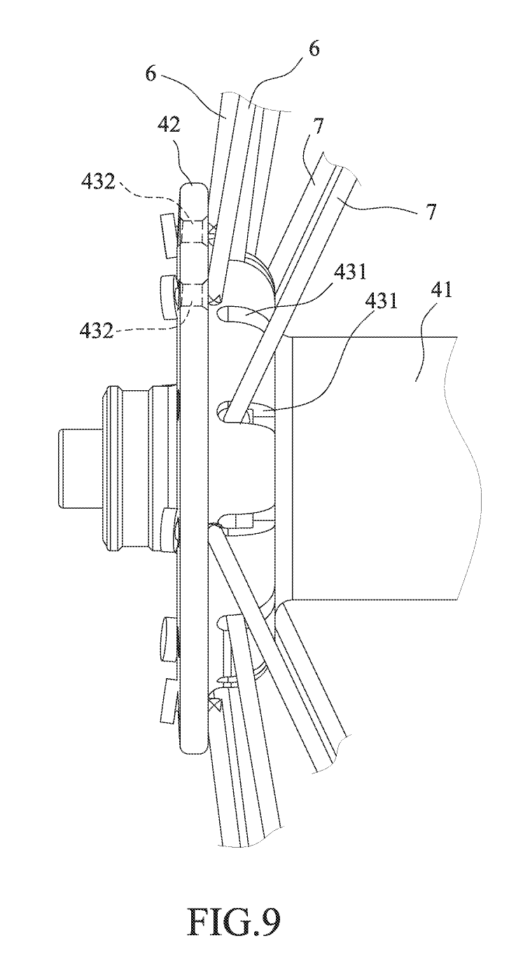

Referring to FIGS. 3, 8 and 9, to be more specific, each of the first spokes 6 further has a first spoke body 61 and a first fixing portion 62. Each of the first mounting holes 431 of the mounting hole unit 43 of each of the hub shells 42 has a width slightly larger than that of the first spoke body 61 of the corresponding one of the first spokes 6, and smaller than that of the first fixing portion 62 of the first spoke 6. The first spoke body 61 of each of the first spokes 6 extends through the corresponding one of the first mounting holes 431, and the first fixing portion 62 of the first spoke 6 abuts against a side of the base wall 421 of the corresponding one of the hub shells 42 such that the first spoke 6 is prevented from detaching from the hub shell 42. Similarly, each of the second spokes 7 further has a second spoke body 71 and a second fixing portion 72. Each of the second mounting holes 432 of the mounting hole unit 43 of each of the hub shells 42 has a width slightly larger than that of the second spoke body 71 of the corresponding one of the second spokes 7, and smaller than that of the second fixing portion 72 of the second spoke 7. The second spoke body 71 of each of the second spokes 7 extends through the corresponding one of the second mounting holes 432, and the second fixing portion 72 of the second spoke 7 abuts against a side of the surrounding wall 422 of the corresponding one of the hub shells 42 such that the second spoke 7 is prevented from detaching from the hub shell 42. In this embodiment, each of the first spokes 6 is a straight pull spoke, and each of the second spokes 7 is a J-bend spoke.

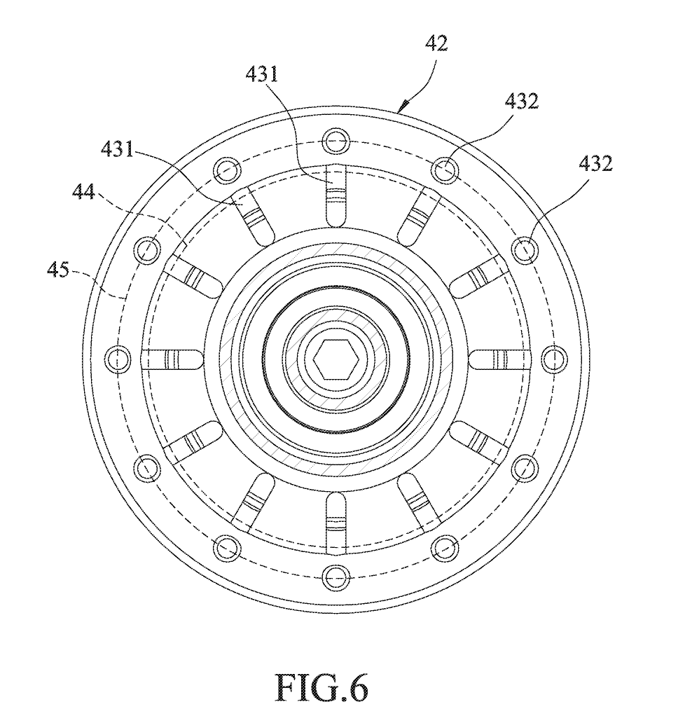

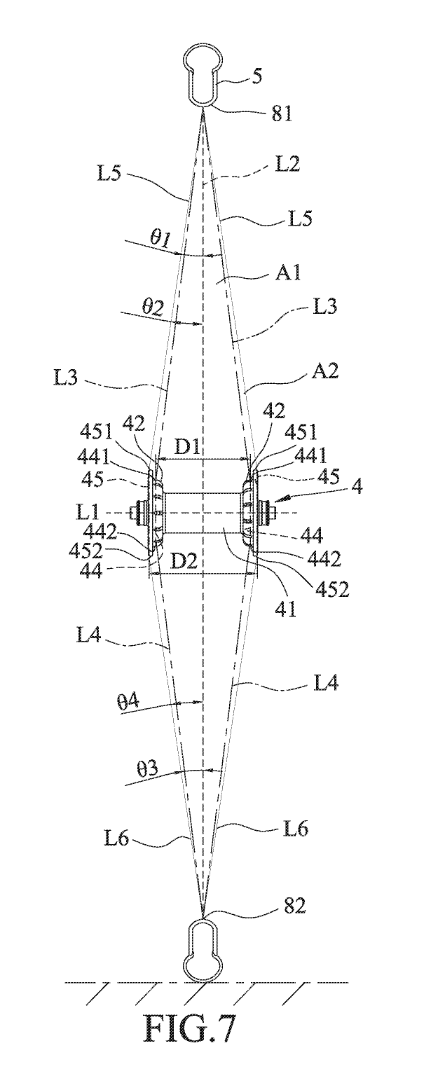

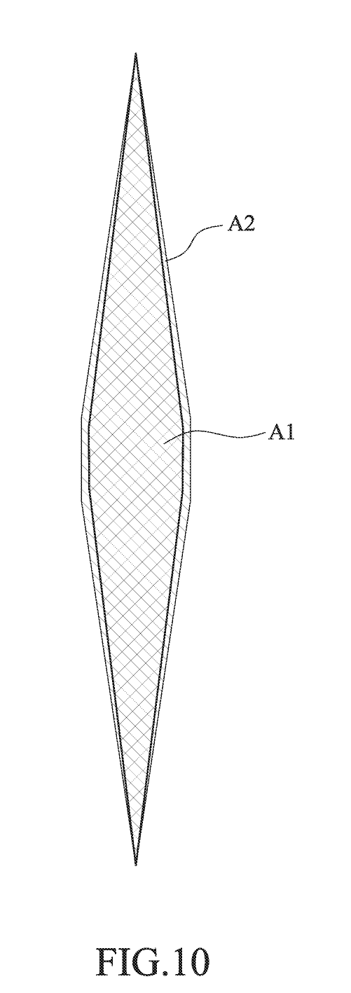

Referring further to FIGS. 6, 7 and 10, the first mounting holes 431 of each of the hub shells 42 surround the central axis (L1) and are spaced apart from the second mounting holes 432 of the hub shell 42. Each of the hub shells 42 is defined to have a first imaginary circle 44 that extends through centers of outer ends of the first mounting holes 431 of the mounting hole unit 43 of the hub shell 42, i.e., ends of the first mounting holes 431 distal from the central axis (L1), and that is centered at the central axis (L1). Each of the hub shells 42 is defined to further have a second imaginary circle 45 that extends through centers of the second mounting holes 432 of the mounting hole unit 43 of the hub shell 42, and that is centered at the central axis (L1). A distance (D1) between the first imaginary circles 44 of the hub shells 42 is smaller than a distance (D2) between the second imaginary circles 45 of the hub shells 42. The first imaginary circle 44 of each of the hub shells 42 has a diameter smaller than that of the second imaginary circle 45 of the hub shell 42.

When viewing in a horizontal direction (H) (see FIG. 3) perpendicular to the central axis (L1):

a vertical rotating line (L2) is defined to contact the wheel frame 5 at upper and lower ends thereof, i.e., an upper frame-connecting point 81 and a lower frame-connecting point 82 disposed under the upper frame-connecting point 81;

two straight first extending lines (L3) are defined to each extend from an upper end 441 of a respective one of the first imaginary circles 44 to the upper intersecting point 81;

two straight second extending lines (L4) are defined to each extend from a lower end 442 of a respective one of the first imaginary circles 44 to the lower intersecting point 82;

two straight third extending lines (L5) are defined to extend from an upper end 451 of a respective one of the second imaginary circles 45 to the upper intersecting point 81;

two straight fourth extending lines (L6) are defined to each extend from a lower end 452 of a respective one of the second imaginary circles 45 to the lower intersecting point 82;

a first stress region (A1) is defined among the first extending lines (L3), first imaginary circles 44 and the second extending lines L4; and

a second stress region (A2) is defined among the third extending lines (L5), the second imaginary circles 45 and the fourth extending lines (L6).

Each of the first extending lines (L3) cooperates with the rotating line (L2) to define a first angle (θ1) therebetween. Each of the third extending lines (L5) cooperates with the rotating line (L2) to define a second angle (θ2) therebetween that is larger than the first angle (θ1). Each of the second extending lines (L4) cooperates with the rotating line (L2) to define a third angle (θ3) therebetween. Each of the fourth extending lines (L6) cooperates with the rotating line (L2) to define a fourth angle (θ4) therebetween that is larger than the third included angle (θ3).

It is noted that the first stress region (A1) is a stress region defined by the first spokes 6 when rotating about the central axis (L1), and the second stress region (A2) is a stress region defined by the second spokes 7 when rotating about the central axis (L1). When one of one type of spokes 6, 7 is broken, the other type of the spokes 6, 7 is still capable of evenly distributing the stress on the wheel frame 5. For example, when one of the first spokes 6 is broken, the second spokes 7 can evenly distribute the stress on the wheel frame 5. The first stress region (A1) has an area different from that of the second stress region (A2). In this embodiment, the area of the first stress region (A1) is smaller than the area of the second stress region (A2).

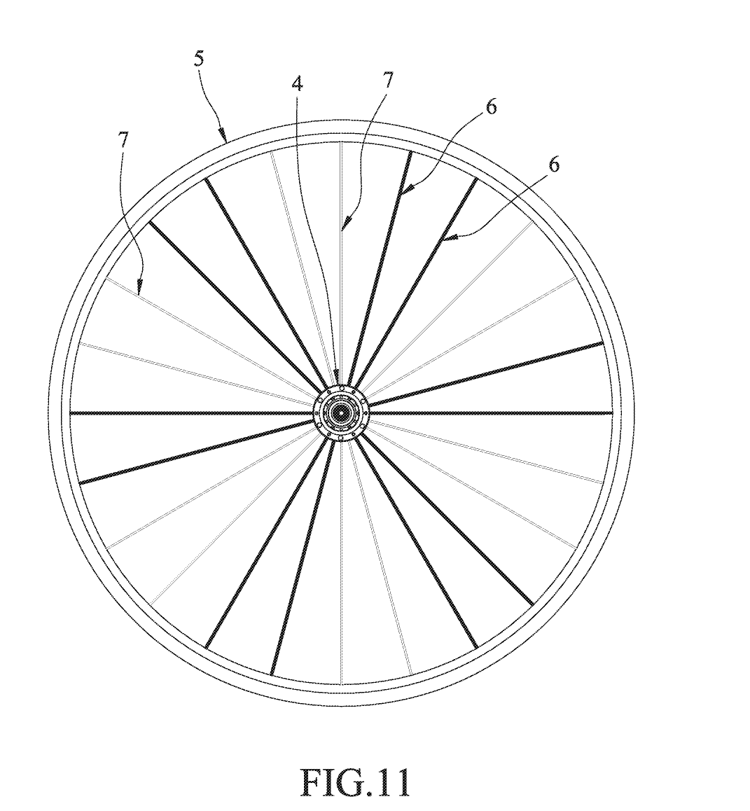

As shown in FIG. 11, when viewing from a lateral side of the wheel, the first spokes 6 do not intersect with the second spokes 7.

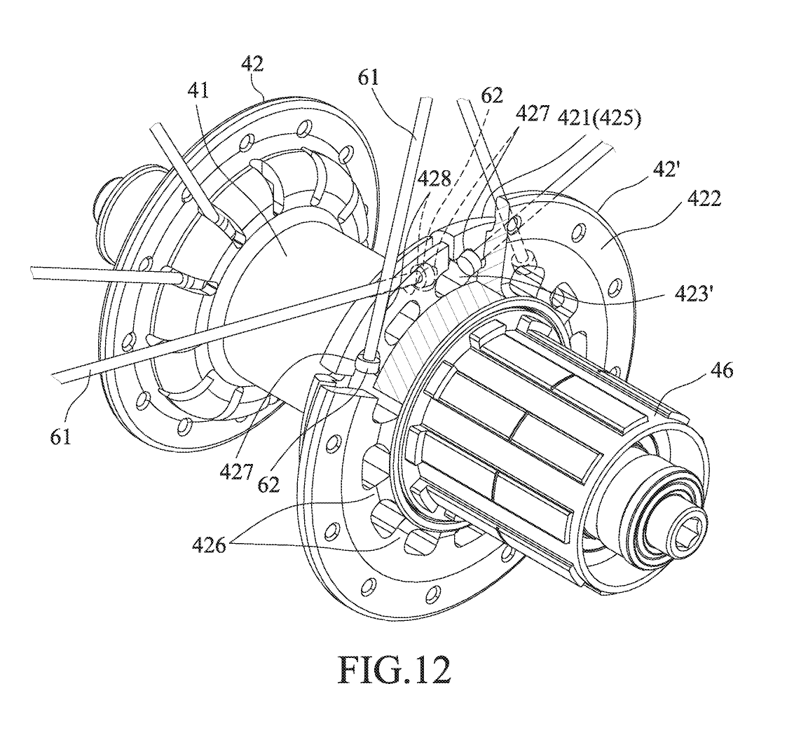

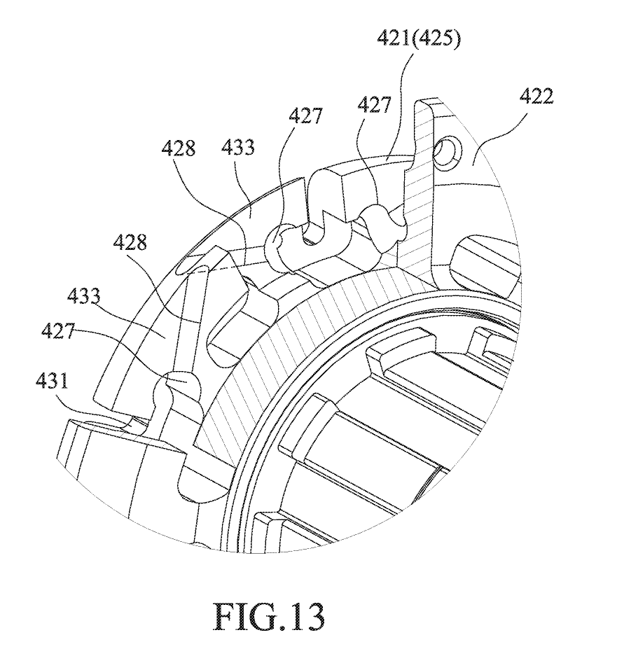

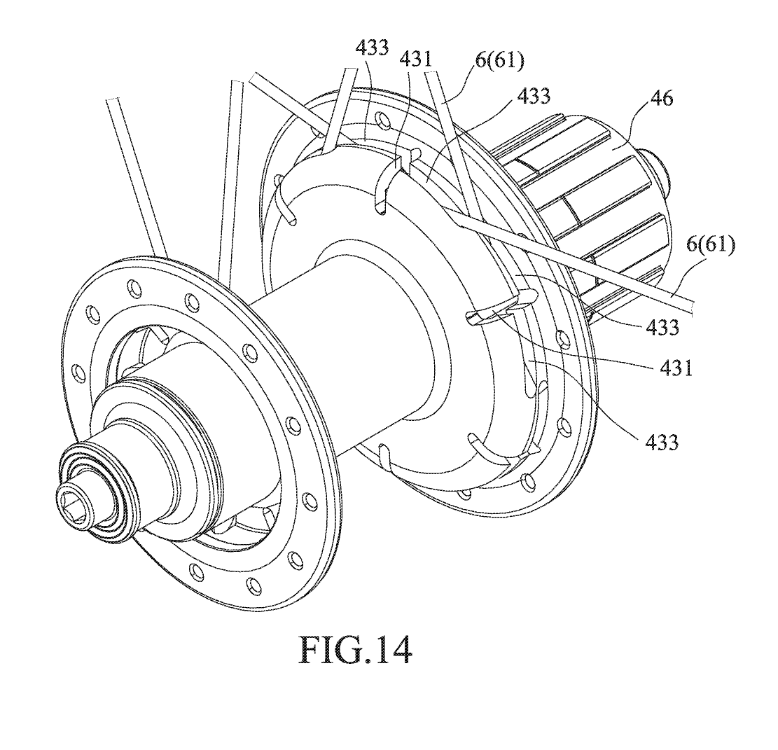

Referring to FIGS. 12 to 14, a second embodiment of the wheel according to the present disclosure has a structure similar to that of the first embodiment, with differences described blow. In the second embodiment, the wheel hub 4 of the wheel further includes a transmission member 46 that is connected to one of the opposite ends of the hub body 41. The hub shell 42′ that is proximate to the transmission member 46 has a dimension larger than that of the hub shell 42 distal from the transmission member 46. In this embodiment, the hub shell 42′ further includes a plurality of connecting ribs 426 that are connected among the hub body 41, the base wall 421 and the surrounding wall 422, and that define a plurality of surrounding space portions 423′. Each of the surrounding space portions 423′ is formed between two adjacent ones of the connecting ribs 426, and is in spatial communication with a respective one of the first mounting holes 431. In this embodiment, the mounting hole unit 43 of the hub shell 42′ further includes a plurality of third mounting holes 433 that are formed in the base wall 421 and that surround the central axis (L1). Each of the third mounting holes 433 is in spatial communication with a corresponding one of the first mounting holes 431. Any two adjacent ones of the third mounting holes 433 are spaced apart from each other in the axial direction (A). In this embodiment, the hub shell 42′ further includes a plurality of fixing holes 427 that are respectively formed in the connecting ribs 426, and a plurality of positioning holes 428. Each of the positioning holes 428 extends from a respective one of the fixing holes 427 in a direction inclined with respect to the central axis (L1), and terminates at an outer surface of the base wall 421. Each of the fixing holes 427 is in spatial communication with the respective one of the positioning holes 428, a respective one of the first mounting holes 431 and a corresponding one of the third mounting holes 433. During assembly, each of the first spokes 6 is moved through a corresponding one of the surrounding space portions 423′, the respective one of the first mounting holes 431, and the corresponding one of the third mounting holes 433, and is inserted through a corresponding one of the positioning holes 428 until the first spoke body 61 of each of the first spokes 6 abuts against an inner wall defining the corresponding one of the positioning holes 428, and the first fixing portion 62 of the first spoke 6 is fixed in the respective one of the fixing holes 427.

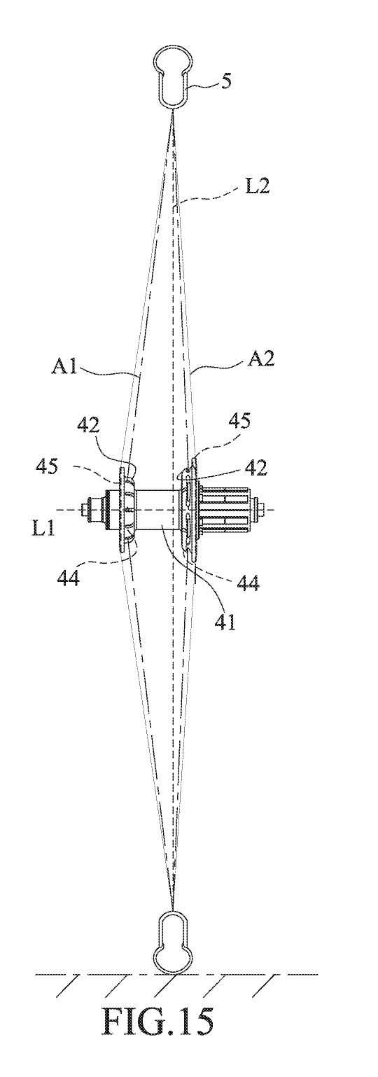

As shown in FIG. 15, the first stress area (A1) and the second stress area (A2) of the second embodiment are not symmetrical relative to the rotating line (L2).

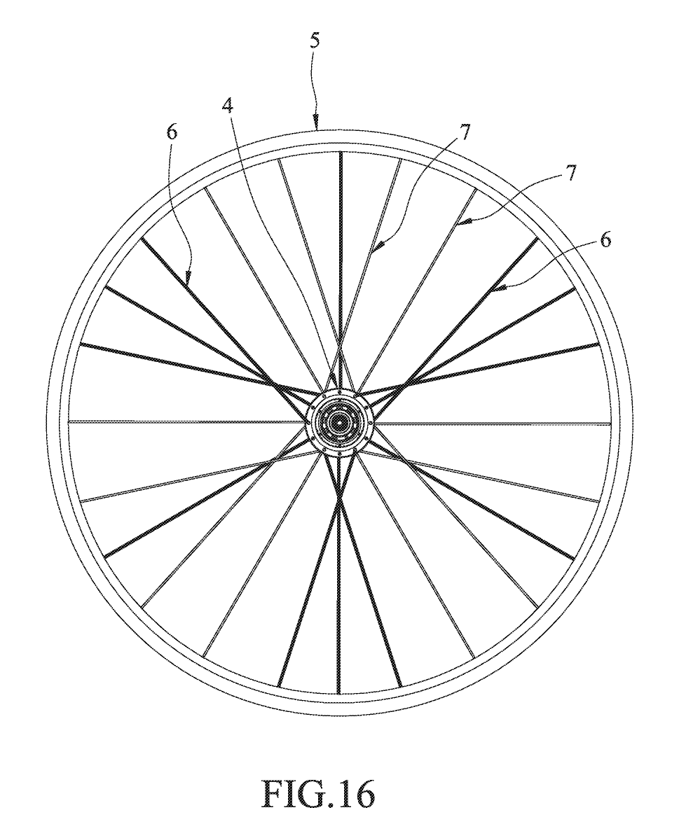

As shown in FIG. 16, when viewing from a lateral side of the wheel of the second embodiment, the first spokes 6 intersect with the second spokes 7.

To Sum up, with the configuration of the base wall 421, and the first and second mounting holes 431, 432, the wheel of this disclosure is capable of accommodating two kinds of spokes 6, 7, such as straight pull and J-bend spokes. Moreover, with the first and second spokes 6, 7 defining the first and second stress areas (A1, A2), when one type of spokes 6, 7 is broken, the other type of the spokes 6, 7 is still capable of evenly distributing the stress on the wheel frame 5.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A wheel hub adapted to be mounted with a plurality of spokes, said wheel hub comprising:
a hub body that extends about a central axis; and
two hub shells that are respectively connected to opposite ends of said hub body, each of said hub shells including
a base wall that has a first base portion extending radially and outwardly from said hub body, and a second base portion extending from said first base portion in an axial direction relative to the central axis,
a surrounding wall that extends radially and outwardly from said second base portion of said base wall, and
a mounting hole unit that includes a plurality of first mounting holes formed in said base wall and spaced apart from each other, and a plurality of second mounting holes formed in said surrounding wall and spaced apart from each other, each of said first and second mounting holes being adapted to permit a corresponding one of the spokes to be mounted to said base wall therethrough.

2. The wheel hub as claimed in claim 1, wherein each of said hub shells further includes a surrounding space that is defined by said hub body, said first base portion and said second base portion, and that is in spatial communication with said first mounting holes.

3. The wheel hub as claimed in claim 1, wherein said second base portion of each of said hub shells extends away from the other one of said hub shells.

4. The wheel hub as claimed in claim 1, wherein each of said second mounting holes of said mounting hole unit of each of said hub shells extends through said surrounding wall of said hub shell in the axial direction.

5. The wheel hub as claimed in claim 1, wherein each of said first mounting holes of said mounting hole unit of each of said hub shells extends from said first base portion of said base wall of said hub shell into said second base portion.

6. The wheel hub as claimed in claim 5, further comprising a transmission member that is connected to one of said opposite ends of said hub body.

7. The wheel hub as claimed in claim 6, wherein, in one of said hub shells that is proximate to said transmission member, said hub shell further includes a plurality of connecting ribs that are connected among said hub body, said base wall and said surrounding wall, and that define a plurality of surrounding space portions, each of said surrounding space portions being formed between two adjacent ones of said connecting ribs and being in spatial communication with a respective one of said first mounting holes.

8. The wheel hub as claimed in claim 7, wherein, in one of said hub shells that is proximate to said transmission member, said mounting hole unit further includes a plurality of third mounting holes that are formed in said base wall and that surround the central axis, each of said third mounting holes being in spatial communication with a corresponding one of said first mounting holes such that, during assembly, each of said first spokes is moved through a corresponding one of said surrounding space portions and the respective one of said first mounting holes and into said corresponding one of said third mounting holes.

9. The wheel hub as claimed in claim 8, wherein any adjacent ones of said third mounting holes are spaced apart from each other in the axial direction.

10. The wheel hub as claimed in claim 9, wherein the one of said hub shell that is proximate to said transmission member further includes a plurality of fixing holes that are respectively formed in said connecting ribs, and a plurality of positioning holes, each of said positioning holes extending from a respective one of said fixing holes in a direction inclined with respect to the central axis and terminating at an outer surface of said base wall, each of said fixing holes being in spatial communication with a respective one of said positioning holes, a respective one of said first mounting holes and a corresponding one of said third mounting holes, so as to permit a corresponding one of the spokes to be inserted through and fixed into a corresponding one of said positioning holes.

11. A wheel comprising:
a wheel hub including a hub body that extends about a central axis, and two hub shells that are respectively connected to opposite ends of said hub body, each of said hub shells including
a base wall that has a first base portion extending radially and outwardly from said hub body, and a second base portion extending from said first base portion in an axial direction relative to the central axis,
a surrounding wall that extends radially and outwardly from said second base portion of said base wall, and
a mounting hole unit that includes a plurality of first mounting holes formed in said base wall and spaced apart from each other, and a plurality of second mounting holes formed in said surrounding wall and spaced apart from each other;
a wheel frame that surrounds said wheel hub, that is rotatable about the central axis, and that is formed with a plurality of securing holes spaced apart from each other;
a plurality of first spokes, each of said first spokes having opposite ends that are respectively secured into a corresponding one of said first mounting holes of said mounting hole unit of a corresponding one of said hub shells, and a corresponding one of said securing holes; and
a plurality of second spokes, each of said second spokes having opposite ends that are respectively secured into a corresponding one of said second mounting holes of said mounting hole unit of a corresponding one of said hub shells, and a corresponding one of said securing holes.

12. The wheel as claimed in claim 11, wherein:
said first mounting holes of each of said hub shells surround the central axis and are spaced apart from said second mounting holes of said hub shell;
each of said hub shells is defined to have a first imaginary circle that extends through centers of an end of each of said first mounting holes of said mounting hole unit of said hub shell distal from the central axis and that is centered at the central axis;
each of said hub shells is defined to have a second imaginary circle that extends through centers of said second mounting holes of said mounting hole unit of said hub shell and that is centered at the central axis; and
a distance between said first imaginary circles of said hub shells is smaller than a distance between said second imaginary circles of said hub shells.

13. The wheel as claimed in claim 12, wherein said first imaginary circle of each of said hub shells has a diameter smaller than that of said second imaginary circle of said hub shell.

14. The wheel as claimed in claim 13, wherein, when viewing in a horizontal direction perpendicular to the central axis:
a vertical rotating line is defined to contact said wheel frame at an upper frame-connecting point and a lower frame-connecting point disposed under the upper frame-connecting point;
two straight first extending lines are defined to each extend from an upper end of a respective one of said first imaginary circles to the upper intersecting point;
two straight second extending lines are defined to each extend from a lower end of a respective one of said first imaginary circles to the lower intersecting point;
two straight third extending lines are defined to extend from an upper end of a respective one of said second imaginary circles to the upper intersecting point;
two straight fourth extending lines are defined to each extend from a lower end of a respective one of said second imaginary circles to the lower intersecting point;
a first stress region is defined among the first extending lines, first imaginary circles and the second extending lines; and
a second stress region is defined among the third extending lines, the second imaginary circles and the fourth extending lines, the first stress region having an area different from that of the second stress region.

15. The wheel as claimed in claim 14, wherein each of the first extending lines cooperates with the rotating line to define a first angle therebetween, each of the third extending lines cooperating with the rotating line to define a second angle therebetween that is larger than the first angle, each of the second extending lines cooperating with the rotating line to define a third angle therebetween, each of the fourth extending lines cooperating with the rotating line to define a fourth angle therebetween that is larger than the third included angle.

16. The wheel as claimed in claim 15, wherein the area of the first stress region is smaller than the area of the second stress region.

17. The wheel as claimed in claim 12, wherein each of said first spokes is a straight pull spoke, each of said second spokes being a J-bend spoke.
